(19) United States
(12) Patent Application Publication
(10) Pub. No.: US 2026/0162153 A1
(43) Pub. Date: Jun. 11, 2026

(54) SYSTEM AND METHOD FOR PROPERTY ANALYSIS

(71) Applicant: Cape Analytics, Inc., Palo Alto, CA (US)

(72) Inventors: Jenny Yang, Palo Alto, CA (US); Jonathan M. Fisher, Palo Alto, CA (US)

(21) Appl. No.: 19/402,661

(22) Filed: Nov. 26, 2025

Related U.S. Application Data
(60) Provisional application No. 63/728,848, filed on Dec. 6, 2024.

(51) Int. Cl. G06Q 30/02; G06Q 50/16

(52) U.S. Cl. CPC G06Q 30/0278; G06Q 50/16

(57) ABSTRACT

Systems and methods for estimating a living area of a property using a machine learning architecture that processes multi-view image measurements are disclosed. A machine learning model may generate a feature map for each measurement of a set of measurements associated with a property of interest. The model determines embeddings and corresponding positional encodings for the living area of the property of interest based on features in the feature maps. A weighted probability interest distribution representative of the living area is then determined by the model based on the embeddings and corresponding positional encoding for the living area.

### CROSS-REFERENCE TO RELATED APPLICATIONS

This application claims priority to U.S. Provisional Application No. 63/728,848 entitled “SYSTEM AND METHOD FOR PROPERTY ANALYSIS”, filed Dec. 6, 2024, the entire contents of which are incorporated by reference herein.

### TECHNICAL FIELD

This invention relates generally to the real estate field, and more specifically to a new and useful system and method for property analysis in the real estate field.

### BACKGROUND

Traditional image-based property analysis systems have largely relied on convolutional neural networks (CNNs) or other spatially local architectures to extract visual features for valuation or measurement tasks. While CNNs are effective at learning local patterns such as edges or textures, they are inherently limited in capturing long-range spatial dependencies across an image, particularly when analyzing multi-view or multi-modal property imagery. In the context of determining physical attributes such as living area, roof geometry, or building footprint, local receptive fields can fail to model structural relationships spanning multiple roof planes or between different elevations of the same building. As a result, conventional CNN-based systems can exhibit degraded performance when image inputs are incomplete, occluded, or derived from differing viewing angles, leading to poor generalization across diverse property types and geographies.

Moreover, many legacy systems for property analysis depend heavily on structured data sources, such as assessor records or manual annotations, which can be incomplete or outdated. When visual data is incorporated, these systems frequently process each image independently. As a result, variations in illumination, perspective, and scene geometry can introduce feature misalignment across images, complicating the inference of property-level attributes derived from visual measurements. Consequently, there remains a need for improved computational approaches that more effectively utilize available image data to infer physical characteristics of properties with greater accuracy and consistency.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, the techniques described herein may relate to a method for determining a living area of a property of interest. The method may include generating, using a machine learning model, a feature map for each measurement of a set of measurements associated with a property of interest, and determining, using the machine learning model, embeddings and corresponding positional encoding for a living area of the property of interest based on features in the feature maps. The method may further include determining, using the machine learning model, a weighted probability distribution representative of the living area based on the embeddings and corresponding positional encoding for the living area.

In some embodiments, the set of measurements may be a plurality of images with different views of the property of interest. In further embodiments, the plurality of images may include at least one image encoding depth information.

In further embodiments, the method may further include further appending a randomly initialized vector to the embedding.

According to some embodiments, the method may further include determining whether each measurement of the set of measurements satisfies a predetermined condition, and determining a set of solutions for the measurement and modifying the measurement based on the set of solutions based on whether the measurement satisfies the predetermined condition.

According to other embodiments, the method may yet further include determining a square footage of an image in the set of measurements; determining a living area ratio based on the weighted probability distribution and the square footage of the image; and predicting a value representative of the living area based on the living area ratio and the square footage of the image. The method may also include determining an uncertainty parameter associated with the weighted probability distribution representative of the living area.

The machine learning model may include an encoder and a vision transformer. In some embodiments, the vision transformer may be configured to fuse the embeddings into a tokenized representation of the property of interest using attention of each measurement.

According to some embodiments, the machine learning model may be trained by discretizing a target value range for a value representative of the living area into a plurality of non-equally spaced points, encoding the plurality of non-equally spaced points as non-negative weighted distributions, and training the machine learning model to predict softmax probability distributions over the plurality of non-equally spaced points.

According to other aspects, the techniques described herein relate to a system for determining a living area of a property of interest. The system may include a processor and a memory containing instructions executable by the processor. The processor may execute the instructions to generate, using a machine learning model, a feature map for each measurement of a set of measurements associated with a property of interest. In some embodiments, the set of measurements may include a plurality of images with different views. In further embodiments, the plurality of images includes at least one image encoding depth information.

The processor may further determine, using the machine learning model, embeddings and corresponding positional encoding for a living area of the property of interest based on features in the feature maps determined for the set of measurements and determine, using the machine learning model, a weighted probability distribution representative of the living area based on the embeddings and corresponding positional encoding for the living area.

The machine learning model may include an encoder and a vision transformer. In such embodiments, the vision transformer may be configured to fuse the embeddings into a tokenized representation of the property of interest using attention of each measurement. In some applications, the machine learning model may be trained by discretizing a target value range for a value representative of the living area into a plurality of non-equally spaced points, encoding the plurality of non-equally spaced points as non-negative weighted distributions, and training the machine learning model to predict softmax probability distributions over the plurality of non-equally spaced points.

In some embodiments, the memory may contain further instructions executable by the processor to determine whether each measurement of the set of measurements satisfies a predetermined condition and determine a set of solutions for the measurement and modify the measurement based on the set of solutions based on whether the measurement satisfies the predetermined condition. In one application, the processor may further determine an uncertainty parameter associated with the weighted probability distribution representative of the living area.

In other embodiments, the memory may contain further instructions executable by the processor to determine a square footage of an image in the set of measurements, determine a living area ratio based on the weighted probability distribution and the square footage of the image, and predict a value representative of the living area based on the living area ratio and the square footage of the image.

In yet other aspects, the techniques described herein relate to a method, including retrieving an image depicting a property of interest, generating a feature map for the image, determining a weighted probability distribution for a living area of the property of interest based on the feature map, determining a living area ratio based on the weighted probability distribution and an area of the image, and estimating, using a machine learning model, a value representative of the living area of the property of interest based on the living area ratio and the area of the image.

### BRIEF DESCRIPTION OF THE FIGURES

Illustrative embodiments of the present application are described in detail below with reference to the following figures:

FIG. 1 is a schematic representation of the method.

FIG. 2 is an illustrative example of a living area model including a first model and a second model.

FIG. 3 is an illustrative example of training a second model.

FIG. 4 is an illustrative example of inputting a sequence of images into a living area model.

FIG. 5 is a block diagram of an example transformer in accordance with some aspects of the disclosure.

FIG. 6 is a block diagram illustrating an example computing system of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. Various changes may be made in the function and arrangement of elements without departing from the spirit and scope of the application as set forth in the appended claims.

### 1. Overview

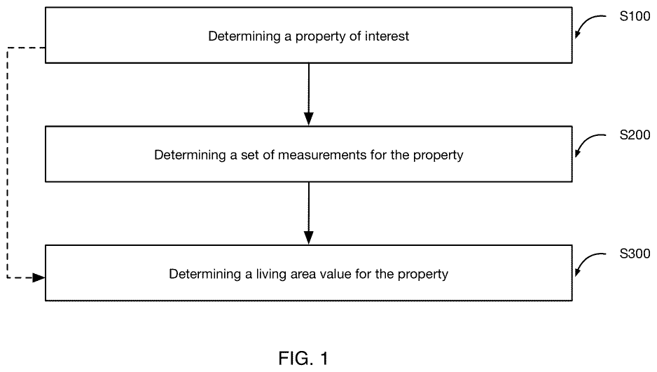

As shown in FIG. 1, the method for property analysis can include: determining a property of interest S100, determining a set of measurements for the property S200, and determining a living area value for the property S300. However, the method can additionally and/or alternatively include any other suitable elements.

The method functions to predict a value representative of living area (e.g., above-ground living area) of a property, based on a set of measurements for the property.

In an illustrative example, the method can include: receiving a property of interest (such as single-family home); determining multi-view orthogonal and oblique image chips depicting the property; optionally determining depth information (such as a digital surface model or height map) for the property; optionally triggering a failure mode (such as bad registration in oblique chips, properties that are not single-family detached, severe occlusion) when an image does not satisfy conditions; optionally determining a solution (such as segmenting based on oblique polygons and/or orthogonal roof polygons, occlusion infilling, segmenting an image of a multi-family property into images with individual units) based on the failure; optionally modifying the image based on the solution; determining a trained living area model that includes a first model (e.g., model backbone, encoding layers from a different model, stand-alone visual encoder, etc.) and a second model (e.g., visual transformer, decoding layers, etc.); inputting the multi-view orthogonal and oblique image chips (in a sequence) and optionally the depth information into the first model that outputs feature maps with each feature map corresponding to an image; determining vector embeddings and optionally positional encodings based on the feature maps; optionally appending a randomly initialized vector to the linear vector embeddings; optionally encoding the vector embeddings with positional encodings; inputting the vector embeddings into the second model that outputs a living area weighted probability distribution and optionally a confidence score; optionally determining a living area ratio (e.g., ratio between above ground living area (square footage) and image chip area (square footage)) based on the weighted probability distribution; optionally determining a living area (square footage) based on the living area ratio and an image chip area (square footage); and optionally providing the living area (square footage) to an endpoint through an interface. The second model (e.g., vision transformer) is trained to predict living area weighted probability distributions for the training properties based on the training properties'images, wherein the weighted probability distributions are compared against the target weighted probability distributions, and the second model is updated based on the comparison (via cross-entropy loss, other loss functions, etc.). The target living area weighted probability distribution is determined by: determining a (ground-truth) living area (square footage); normalizing the living area (square footage) by determining a living area ratio based on the living area (square footage) and an image chip area (square footage); optionally determining a logarithm value of the living area ratio; discretizing the target range (e.g., into n grid points, into equally-spaced points, into non-equally-spaced points, etc.) of the living area ratio; and encoding the target values as a living area weighted (softmax) probability distribution.

### 2. Technical Advantages

Variants of the technology for property analysis can confer several benefits over conventional systems and benefits.

First, variants of the technology can predict a living area value of a property leveraging a vision transformer. The inventors have discovered that switching to a vision transformer from a CNN significantly improved performance as the vision transformer processes images by dividing them into patches and analyzes how these patches relate to the final target. This approach generates richer (linear) embeddings and captures more detailed spatial relationships compared to the CNN, leading to significant improvements in the model's performance. Additionally, the vision transformer processes multi-view images in a sequence, treating each view as a token, similar to how transformers process word sequences. This led to an improved model through this sequence-based approach.

Second, neural networks trained on continuous target values are prone to overfitting. Since the model must predict any value within an infinite range of values, this can lead the neural network to memorize the noise and anomalies in the training data rather than approximate the true underlying function. To overcome this, the inventors have discovered using a discretized regression approach. When the target value range is continuous, the target value range is discretized (into n grid points) and the target values are encoded as non-negative weighted distributions (soft targets). The model is trained to predict softmax probability distributions over the grid points. This converts the regression problem into a classification-like framework, where outputs are constrained to be non-negative and sum to 1. Model predictions, represented as probability distributions, can then be converted back into continuous values for direct comparison or conversion to square footage.

Third, transformers, as standalone models, lack some of the inductive biases inherent to CNNs, making them less effective at generalizing well when trained on limited data. To overcome this, variants of the technology can leverage multi-view imagery (e.g., orthogonal, north view oblique, east view oblique, south view oblique, west view oblique, etc.) other types of imagery (e.g., aerial imagery, non-aerial imagery, imagery from multiple listing service, etc.), and/or beyond imagery (e.g., multi-modal data, structured data, unstructured data, etc.) to compile a large training dataset.

However, the technology can confer any other suitable benefits.

### 3. Method

The method can include: determining a property of interest S100, determining a set of measurements for the property S200, and determining a living area value for the property S300. However, the method can be otherwise performed.

One or more instances of the method can be performed for one or more properties of interest, one or more times (e.g., timestamps, timesteps, time windows, time frames, etc.), and/or otherwise performed. All or portions of the method can be performed by a remote system (e.g., a platform), a local system, a third-party system, an in-house system, and/or otherwise performed. All or portions of the method can be performed: in response to a request (e.g., an API request) from an endpoint, before receipt of a request, and/or any other suitable time. The method may be performed once, iteratively, responsive to occurrence of a predetermined event, and/or at any other time. According to one embodiment, an instance of the method may be performed using all available object information (e.g., measurements) for a property of interest, wherein are extracted from each piece of available object information and evaluated in combination to determine a living space area for a property of interest. In other embodiments, an instance of the method may be performed using a specific set of measurements (e.g., oblique images,, etc.). However, the method can be performed at any time, using any other suitable set of object information.

According to one embodiment, the method may be performed by a remote system (e.g., platform, cloud platform, etc.). In other embodiments, the method may additionally and/or alternatively be performed by a local system or be performed by any other suitable system. The remote system can include a set of processing systems (e.g., configured to execute all or portions of the method, the models, etc.), storage (e.g., configured to store the object representations, object versions, data associated with the object versions, etc.), and/or any other suitable component.

The method may be performed using one or more models. The model(s) may include: a neural network (e.g., CNN, DNN, encoder, etc.), a visual transformer, a combination thereof, an object detector (e.g., classical methods, CNN based algorithms, such as Region-CNN, fast RCNN, faster R-CNN, YOLO, SSD-Single Shot MultiBox Detector, R-FCN, etc.; feed forward networks, transformer networks, generative algorithms, diffusion models, GANs, etc.), a segmentation model (e.g., semantic segmentation model, instance-based semantic segmentation model, etc.), leverage regression, classification, rules, heuristics, equations (e.g., weighted equations), instance-based methods (e.g., nearest neighbor), decision trees, support vectors, geometric inpainting, Bayesian methods (e.g., Naïve Bayes, Markov, etc.), kernel methods, statistical methods (e.g., probability), deterministic, clustering, and/or include any other suitable model or algorithm. Each model may determine (e.g., predict, infer, calculate, etc.) an output based on: one or more measurements depicting the object, tabular data (e.g., attribute values, auxiliary data), other object information, and/or other information. The model(s) can be specific to an object class (e.g., roof, tree, pool), a sensing modality (e.g., the model is specific to accepting an RGB satellite image as the input), and/or be otherwise specified. One model can be used to extract different representations of the set, but additionally and/or alternatively multiple different models can be used to extract different representations of the set.

The method functions to predict a value representative of the living area (e.g., above-ground living area) of a property, based on a set of measurements for the property.

The property of interest can be a real property (e.g., land and built structure, a built structure, a segment of a built structure, and/or any other suitable subject. The property can be associated with a property class (e.g., single-family home, multi-family home, residential building, commercial building, apartment, condo, co-op, etc.) or not be associated with a property class. The property is preferably a single-family home, but can additionally and/or alternatively be a multi-family home, and/or any other suitable property. The property can be identified by: a property identifier (e.g., an address, a lot number, a block number, a parcel number, etc.), a geographic identifier (e.g., a set of latitude/longitude coordinates, geolocation, etc.), not be associated with an identifier, and/or otherwise identified. The property can be associated with parcel data (e.g., a boundary of a parcel), a property boundary (e.g., a land boundary), a geofence, a region, a mask, and/or any other suitable information.

The property can be associated with a set of property measurements. Each measurement is preferably an image, but can additionally and/or alternatively be a video, audio, depth information (e.g., digital surface model, digital elevation model, etc.), geometric measurements (e.g., 3D point clouds, RADAR, LIDAR, etc.), a virtual model, and/or any other suitable measurement. The image is preferably an image chip (e.g., a segment of a larger image), but additionally and/or alternatively be a source image, and/or any other suitable image. The image chip is preferably a square image chip, but can additionally and/or alternatively be a rectangular image chip, an image chip with any other shape, dimension and/or aspect ratio, and/or any other suitable image chip. The image is preferably a remote image (e.g., an image taken of a remote scene, satellite image, aerial image, drone image, etc.), but can additionally and/or alternatively be a local image, and/or any other suitable image. The image can be an oblique image, an orthogonal image, a top-down image, and/or taken from any other suitable angle. Each measurement can depict: only the property of interest (e.g., a property-specific measurement, wherein a wide-scale measurement depicting the property can be cropped using the parcel data); depict multiple properties that includes the property of interest; not depict the property of interest; and/or depict any other suitable property. Each measurement is preferably the most recent measurement of the property of interest (e.g., based on a timestamp of when the measurement was captured), but can additionally and/or alternatively be an older measurement of the property of interest, and/or a measurement captured at any other suitable time. Each measurement can be associated with contextual parameter values (e.g., associated with the measurement context), or not be associated with contextual parameter values. Contextual parameter values can include: a scene class (e.g., interior scene measurement, exterior scene measurement, etc.), a perspective (e.g., front elevation, top planar view, etc.), a provider, a modality, a season, a time of day, a timestamp, a zoom level (e.g., image chip zoom level), an image padding, and/or any other suitable parameter value. Each measurement can be retrieved from a database, retrieved from a real estate listing service (e.g., a multiple listing service, Redfin™, etc.), received from an image provider (e.g., a satellite image provider, drone image provider, Nearmap™, etc.), received from a real estate appraisal, received from a real estate inspector, and/or otherwise determined.

The property can be associated with auxiliary data. Examples of auxiliary data can include property descriptions, permit data, insurance loss data, inspection data, appraisal data, broker price opinion data, property valuations, property attribute and/or component data (e.g., values), public data, and/or any other suitable data.

The property can be associated with a set of property attributes. Property attributes can include: subjective attributes, structural attributes, neighborhood attributes, market attributes, record attributes, and/or any other suitable attributes.

Subjective attributes can include: property condition, viewshed and/or viewshed desirability, curb appeal, and/or any other suitable attributes. Examples of property condition attributes include: roof condition, building external condition, driveway condition, lawn condition, pool condition, yard debris, roof occlusion, tree overhang, vegetation coverage and/or proximity, overall property condition (e.g., exterior condition), damage detection, quality grade, and/or other condition attributes.

Structural attributes can include: presence or absence of a built structure (e.g., deck, pool, ADU, shed, garage, etc.), physical or geometric attributes of the built structure (e.g., roof surface area, number of roof facets, roof slope, roof pitch, pool surface area, square footage, number of stories, living area, building material type, etc.), relationships between built structures (e.g., distance between built structures, built structure density, etc.), and/or any other suitable attributes.

Neighborhood attributes can include: typicality (e.g., of property relative to neighbors), structural density, and/or any other suitable attributes.

Market attributes can include: liquidity (e.g., how easily a property can be sold without reducing price), geographic region, market state (e.g., bull market, bear market), market interest rates, transaction type (e.g., standard sale, bank-owned or real-estate-owned sale, short sale, etc.), recorded sale price, appraised value, assessed value, estimated market value, and/or any other suitable attributes.

Record attributes can include: number of beds/baths, construction year, square footage, legal class (e.g., residential, mixed-use, commercial, etc.), legal subclass (e.g., single-family vs. multi-family, apartment vs. condominium, etc.), location (e.g., neighborhood, zip code, etc.), location factors (e.g., positive location factors such as distance to park, distance to school; negative location factors such as distance to sewage treatment plants, distance to industrial zones; etc.), population class (e.g., suburban, urban, rural, etc.), school district, orientation (e.g., side of street, cardinal direction, etc.), and/or any other suitable attributes.

However, any other suitable property attributes can be used.

Property attribute values can be determined based on: property measurements, property features, auxiliary data, and/or any other suitable data. Property features can be determined from property measurements, retrieved from a database, and/or otherwise determined. Examples of property features (e.g., objects) that can be detected include: roof, vegetation, garage, sidewalk, pool, deck, and/or any other suitable physical features. Property attribute values are preferably determined using a property attribute model (e.g., an equation, a neural network, rules, heuristics, etc.), but can additionally and/or alternatively be determined using a different model, determined manually (e.g., by a real estate appraiser, by a real estate inspector, etc.), retrieved from a database, and/or otherwise determined.

The living area model functions to predict a living area value for a property. The system can use one or more living area models. For example, the system can be used with different living area models for different: locations (e.g., a zip code, a neighborhood, etc.), property classes (e.g., single-family home, multi-family home, etc.), property subclasses (e.g., industrial zoning, multi-use zoning, office zoning, etc.), property attribute value sets, and/or other parameter values. The living area model can include one or more submodels. The living area model (and submodels thereof) can be and/or include: a neural network (e.g., CNN, DNN, a transformer such as a vision transformer, etc.), an encoder (e.g., encoding layers from a different model, stand-alone visual encoder, autoencoder, etc.), an equation (e.g., weighted equations), leverage regression, classification, rules, heuristics, instance-based methods (e.g., nearest neighbor), regularization methods (e.g., ridge regression), decision trees, Bayesian methods (e.g., Naïve Bayes, Markov, etc.), kernel methods, probability, deterministics, support vectors, and/or any other suitable model or methodology. Inputs of the living area model can be: property measurements (e.g., images, digital surface model, digital elevation model, etc.) for a property of interest, contextual parameter values, property attribute values (e.g., number of stories) for a property of interest, auxiliary data (e.g., appraisal data), embeddings, positional encodings, and/or any other suitable inputs. Outputs of the living area model can be: a living area value (e.g., living area weighted probability distribution, living area square footage, living area ratio, etc.), an uncertainty parameter (e.g., a confidence interval, a confidence score, etc.), feature vectors, feature maps, and/or any other suitable outputs. The living area model can be retrieved from a repository, trained and/or fine-tuned, received from a third-party system, and/or otherwise determined. However, the living area model can be otherwise configured.

The living area model (and submodels thereof) can be trained using: unsupervised learning, supervised learning, self-supervised learning, semi-supervised learning, reinforcement learning, transfer learning, Bayesian optimization, positive-unlabeled learning, using backpropagation methods, zero-shot training, few-shot training, and/or otherwise learned. The model can be learned or trained on: labeled data (e.g., data labeled with the target label), unlabeled data, positive training sets (e.g., a set of data with true positive labels, negative training sets (e.g., a set of data with true negative labels), and/or any other suitable set of data.

In one embodiment, the living area model may be a vision transformer model. The vision transformer model may, in some aspects, use self-attention to identify one or more important features of an object (e.g. property of interest) for determining the living area value. Alternatively, the transformer may use cross-attention.

### 3.1. Determining a Property of Interest S100

Determining a property of interest S100 functions to determine a property to be evaluated. S100 is preferably performed before S200, but can additionally and/or alternatively be performed concurrently with S200, concurrently with S300, and/or any other suitable time. The property of interest is preferably received from a user (e.g., on an interface) but can additionally and/or alternatively be received in a request from an endpoint, and/or otherwise determined. The property of interest can be received as a standalone property, received as part of a set of properties, and/or otherwise received. The set of properties can be determined from: a list of properties, properties within a geographic region, properties currently on the market, and/or otherwise determined. Each property within the set can be identified by its: address, geolocation, parcel number, lot number, block number, and/or any other identifier.

However, the property of interest can be otherwise identified.

### 3.2. Determining a Set of Measurements for the Property S200

Determining a set of measurements for the property S200 functions to determine a set of measurements depicting a property of interest. S200 can be performed after 100, asynchronously with S100, and/or any other suitable time. The set of measurements preferably includes multiple measurements, but can additionally and/or alternatively include one measurement, and/or any other suitable number of measurements. The set of measurements preferably includes images (e.g., square image chips, orthogonal images, oblique images, etc.), but can additionally and/or alternatively include depth information (e.g., digital surface model, digital elevation model, etc.), and/or any other suitable measurement.

In a first variant, S200 can include retrieving a set of measurements depicting the property of interest. In a first example, the set of measurements includes an orthogonal image only. In a second example, the set of measurements includes an orthogonal image, a north view oblique image, an east view oblique image, a south view oblique image, and a west view oblique image. In a third example, the set of measurements includes images (e.g., an orthogonal image and oblique images with differing views) and depth information (e.g., digital surface model, digital elevation model).

In a second variant, S200 can include retrieving a set of measurements depicting the property of interest (described in the above variant) and identifying a set of measurement segments corresponding to the property. The measurement segment is preferably a measurement segment that outlines the property (e.g., cut out of the property), but can additionally and/or alternatively be a measurement segment intersecting the parcel of the property, a measurement segment within the property geofence, a measurement segment intersecting the property boundary, and/or any other suitable measurement segment. The measurement segment is preferably determined using a segmentation model (e.g., semantic segmentation model, instance-based segmentation model, etc.), but can additionally and/or alternatively be determined using an object detector, and/or any other suitable model.

However, the measurement for the property can be otherwise determined.

S200 can optionally include triggering a set of failure modes when the measurement does not satisfy a set of conditions, determining a set of solutions based on the set of failure modes, and modifying the measurement based on the set of solutions. Failure modes can include: bad registration in oblique chips (e.g., particularly in hilly regions), properties that are not single-family detached, severe occlusion, bad roof polygon resulting in cropped chip, bad data from a third-party provider, properties with large attached garages, and/or any other suitable failure mode. Solutions can include: segmenting based on oblique polygons and/or orthogonal roof polygons, inputting multiple image captures from different times of the year into the segmentation model, occlusion detection and/or infilling, segmenting an image of a multi-family property into images with individual units, providing the image to a user for review, requesting updated information, and/or any other suitable solution. In examples, solutions can be defined and/or determined as disclosed in U.S. application Ser. No. 18/121,114 filed 14 Mar. 2023, U.S. application Ser. No. 18/333,803 filed 13 Jun. 2023, each of which is incorporated in its entirety by this reference.

### 3.3. Determining a Living Area Value for the Property S300

Determining a living area value for the property S300 functions to predict a living area value for the property of interest. S300 is preferably performed after S200, but can additionally and/or alternatively be performed after S100, and/or any other suitable time. S300 can be performed: periodically, when requested, at random times, as a batch (e.g., for one or more properties), when new data is received, and/or any other suitable time. The living area is preferably the sum of living areas among all floors above-ground of a property, but can additionally and/or alternatively be a living area of a particular floor (e.g., grand floor living area, second floor living area, etc.) of a property. The living area value is preferably numerical (e.g., a number in any unit, a number with no unit, a range, a ratio, a probability, a distribution, etc.), but can additionally and/or alternatively be categorical (e.g., a ranking, a classification, etc.). The living area value can be represented as a weighted probability distribution, a probability, an area (e.g., in square footage), a ratio, and/or otherwise represented. The living area value can be associated with an uncertainty parameter or not be associated with an uncertainty parameter. Uncertainty parameters can include variance values, a confidence score, a confidence level, a confidence interval (e.g., with 95% confidence, with 99% confidence, etc.), and/or any other uncertainty metric. The living area value is preferably determined using a living area model, but can additionally and/or alternatively be determined using a different model, determined manually (e.g., by a real estate appraiser, by a real estate inspector, etc.), and/or otherwise determined.

In variants, S300 can include using the set of measurements for the property (e.g., determined in S200) as inputs into the living area model that outputs a predicted living area value for the property. The set of measurements preferably includes multiple images with each image depicting a different view of the property, but can additionally and/or alternatively include multiple images depicting the same view, a single image, and/or any other suitable measurement. The set of measurements preferably includes orthogonal images and oblique images but can additionally and/or alternatively include only orthogonal images, only oblique images, and/or any other suitable measurements. The images are preferably the same size (e.g., image chip size), but can additionally and/or alternatively be different sizes.

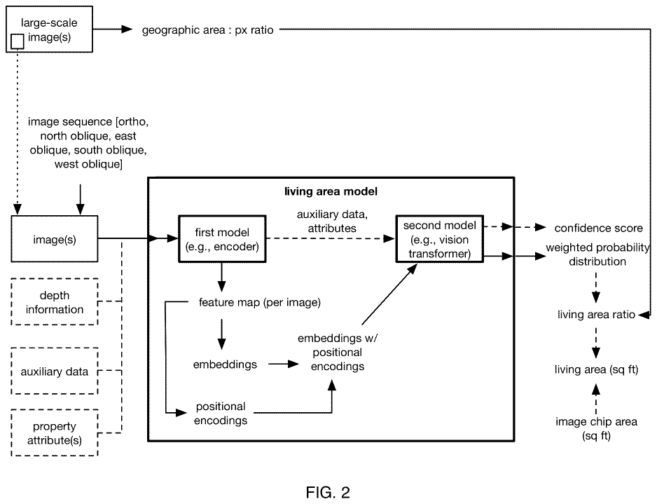

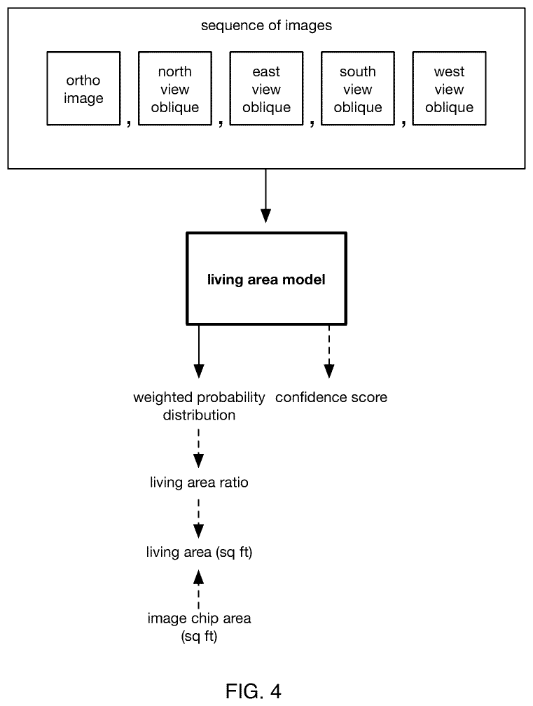

In a first example of this variant, the living area model includes two submodels, which includes a first model and a second model; example shown in FIG. 2. The set of measurements can include multiple images with each image depicting a different view of the property (e.g., orthogonal image, north oblique image, east oblique image, south oblique image, west oblique image, etc.); example shown in FIG. 4. S300 can include: inputting the multiple images (in a sequence) and optionally depth information (e.g., digital surface model, digital elevation model, etc.), auxiliary data (e.g., appraisal data), and/or property attributes (e.g., number of stories) into a first model (e.g., encoding layers of a different model, encoding layers from a CNN trained end-to-end to predict property feature classes, stand-alone visual encoder, model backbone, etc.) that outputs feature maps with each feature map corresponding to an image; determining vector embeddings (e.g., linear vector embeddings) and optionally positional encodings based on the feature maps; optionally appending a randomly initialized vector to the vector embeddings; optionally encoding the vector embeddings with positional encodings (e.g., using sine and cosine functions of varying frequencies); and inputting the vector embeddings and optionally auxiliary data and/or property attributes into a second model (e.g., vision transformer, set of decoding layers, etc.) that outputs a living area value and optionally an uncertainty parameter (e.g., confidence score) associated with the living area value. In this example, the predicted living area value includes a living area weighted probability distribution, where the expected value of the weighted probability distribution is the living area ratio (e.g., ratio between above ground living area (square footage) and image chip area (square footage). The living area (square footage) is calculated based on the living area ratio and the image chip area (square footage). However, the predicted living area value can include the living area ratio, the living area (square footage), and/or any other suitable living area value.

In a second example of this variant, the living area model includes a CNN. S300 can include: inputting the images into a CNN (that fuses the images) that outputs a living area distribution; and inputting the living area distribution and optionally property attributes (e.g., number of stories) into a classical machine learning model (e.g., regression, classification, etc.) that outputs a predicted living area value (e.g., living area square footage).

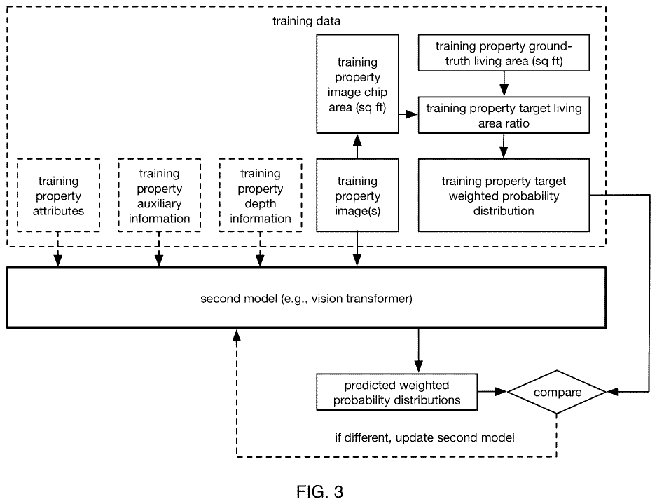

The living area model can be trained based on one or more training properties. The living area model (and submodels thereof) can be trained with a training target or without a training target (e.g., for unsupervised learning). The training target for the living area model is preferably discrete, but can additionally and/or alternatively be continuous, and/or have any other suitable characteristic. The training target for the living area model is preferably numerical, but can additionally and/or alternatively be categorical, and/or have any other suitable characteristic. The training target can be: determined from appraisal data, inspector data, public data (e.g., government records), manually determined (e.g., by an appraiser), determined by a third-party, determined by a different model and/or algorithm, a combination thereof, and/or otherwise determined. Examples of training targets can include: living area (square footage), living area ratio, living area weighted probability distribution, and/or any other suitable training target. In a first example, the training target for a training property includes a living area recorded in appraisal and/or inspector data. In a second example, the training target for a training property includes a living area determined by a third-party (e.g., appraiser, real estate inspection company, etc.). In a third example, the training target for a training property includes a living area weighted probability distribution; example shown in FIG. 3. The living area model is trained to predict living area weighted probability distributions for the training properties based on the training properties'images, wherein the weighted probability distributions are compared against the target weighted probability distributions, and the living area model is updated based on the comparison (e.g., using loss functions such as cross-entropy loss, regression loss, mean squared error, log loss, etc.). In this example, determining the target living area weighted probability distribution can include: determining a (ground-truth) living area (square footage); normalizing the living area (square footage) by determining a living area ratio based on the living area (square footage) and an image chip area (square footage); optionally determining a logarithm value of the living area ratio; discretizing the target range (e.g., into n grid points, into equally-spaced points, into non-equally-spaced points, etc.) of the living area ratio; encoding the target values as a living area weighted probability distribution (e.g., softmax probability distribution); and/or any other suitable step. The discretized target values are preferably not equally distributed, but can additionally and/or alternatively be equally distributed, and/or otherwise distributed.

In certain embodiments, the living area model may include a visual transformer configured to process spatially encoded embeddings derived from multiple image measurements of a property of interest. The visual transformer may be implemented as a sequence-to-sequence architecture that divides each image into fixed-size patches, linearly projects each patch into an embedding space, and applies a series of attention-based operations to capture inter-patch and inter-view dependencies. Each patch embedding may be combined with a positional encoding that preserves spatial locality and orientation of the corresponding region of the property of interest. The transformer thereby produces a set of contextualized embeddings representative of high-order correlations between local structures—such as roof facets, building edges, or vegetation boundaries—and the overall living area value of the property. The output embeddings may be aggregated or pooled to yield a compact representation used to estimate the living area weighted probability distribution.

In one embodiment, the visual transformer may utilize self-attention across the patch embeddings corresponding to a single view or across multiple views of the same property. Self-attention enables the model to evaluate the relevance of each spatial token with respect to every other token within the same feature sequence, thereby identifying globally informative regions while suppressing redundant or noisy background features. In such embodiments, attention weights are learned based on pairwise similarity between query and key projections of the embeddings, allowing the model to adaptively emphasize the features of the property of interest that most strongly influence the living area estimation. Multi-head self-attention may be used to jointly capture relationships at differing spatial scales, such as local roof geometry versus broader contextual features like lot configuration or shadowing. This self-attention mechanism permits the model to learn a global representation of the property without requiring explicit spatial priors or convolutional inductive biases.

In another embodiment, the visual transformer may employ cross-attention between embeddings originating from distinct modalities or views—for example, between orthogonal imagery and oblique imagery, or between RGB imagery and corresponding depth maps. In such configurations, a first sequence of embeddings (e.g., derived from orthogonal imagery) is treated as the query input, while one or more secondary sequences (e.g., derived from oblique views or auxiliary data) are treated as keys and values. The cross-attention module allows the model to align and integrate complementary spatial information across views, effectively reasoning about the three-dimensional geometry of the property. For instance, oblique imagery may resolve facade details that are occluded in the top-down view, while the orthogonal image provides global roof geometry—cross-attention allows the transformer to fuse these complementary features in a learned, data-driven manner. This cross-view interaction improves robustness of the living area prediction when any single viewpoint is degraded by occlusion or misregistration.

In some implementations, the transformer may alternate self-attention layers and cross-attention layers within the same network to jointly capture intra-view and inter-view dependencies. Self-attention layers may refine embeddings within each view independently to ensure local spatial coherence, while cross-attention layers couple information between different views or modalities to achieve multi-view feature fusion. This hierarchical attention structure allows the model to progressively build a unified scene representation that accurately reflects volumetric and planar aspects of the built structure. The fused embeddings may subsequently be decoded by a regression or classification head to output the living area weighted probability distribution or a corresponding confidence parameter.

However, the living area model can be otherwise configured, trained, and/or used.

However, the living area value for the property can be otherwise determined.

S300 can optionally include determining an uncertainty parameter for the living area value. The uncertainty parameter is preferably a confidence score (e.g., probability mass) but can additionally and/or alternatively be a confidence interval, and/or any other suitable uncertainty metric. The uncertainty parameter can be determined by the living area model, a different model, and/or any other suitable model and/or methodology. In an example, determining an uncertainty parameter for the living area value can include: determining a living area weighted probability distribution as the living area value; determining an expected value (e.g., by multiplying the probabilities with the grid points) for the living area weighted probability distribution; determining the bounds (e.g., lower bound and upper bound) for an interval based on a width (e.g., +/−1%, +/−3%, +/−5%, etc.) around the expected value; summing the softmax probabilities for the grid points that fall within the interval to determine the probability mass within the interval; and determining the probability mass as the confidence score for the weighted probability distribution. In another example, determining an uncertainty parameter for the living area value can include: determining a set of quantile regression models (e.g., models that predict the N tile estimates from 0% to 100%); determining a probability density function using quantile estimates (e.g., by plotting the quantile estimate as the independent variable and the quantile as the dependent variable); determining the area under the probability density function for the interval of the median estimate based on a width (e.g., +/−10%), wherein the area can be determined based on a difference between the cumulative distribution function at a width above the median estimate (e.g., +10% the median estimate) and the cumulative distribution function at a width below the median estimate (e.g., −10%); and determining the area as the confidence score. However, the uncertainty parameter for the living area value can be otherwise determined.

S300 can optionally include providing the value to an endpoint through an interface. The endpoint can be: an endpoint on a network, a customer endpoint, a user endpoint, an AVM system, a real estate listing service, an insurance system, a real estate appraisal system, an inspection system, and/or any other suitable endpoint. The interface can be: a mobile application, a web application, a desktop application, an API, a database, and/or any other suitable interface. However, the living area value for the property can be otherwise provided.

### 4. Use Cases

The estimated living area value can be used in various applications. The value can be used in: real estate valuation and/or appraisal (e.g., use living area value as an input to an automated valuation model; use living area value to detect error in property valuation models; use living area value as a supplement to a property-level valuation report; use living area value to detect error in data inputted by a customer; etc.).

However, the value can be otherwise used.

The method can optionally include determining interpretability and/or explainability of the trained model, wherein the identified attributes (and/or values thereof) can be provided to a user, used to identify errors in the data, used to identify ways of improving the model, and/or otherwise used. Interpretability and/or explainability methods can include: local interpretable model-agnostic explanations (LIME), Shapley Additive explanations (SHAP), Ancors, DeepLift, Layer-Wise Relevance Propagation, contrastive explanations method (CEM), counterfactual explanation, Protodash, Permutation importance (PIMP), L2X, partial dependence plots (PDPs), individual conditional expectation (ICE) plots, accumulated local effect (ALE) plots, Local Interpretable Visual Explanations (LIVE), breakDown, ProfWeight, Supersparse Linear Integer Models (SLIM), generalized additive models with pairwise interactions (GA2Ms), Boolean Rule Column Generation, Generalized Linear Rule Models, Teaching Explanations for Decisions (TED), and/or any other suitable method and/or approach.

All or a portion of the models discussed above can be debiased (e.g., to protect disadvantaged demographic segments against social bias, to ensure fair allocation of resources, etc.), such as by adjusting the training data, adjusting the model itself, adjusting the training methods, and/or otherwise debiased. Methods used to debias the training data and/or model can include: disparate impact testing, data pre-processing techniques (e.g., suppression, massaging the dataset, apply different weights to instances of the dataset), adversarial debiasing, Reject Option based Classification (ROC), Discrimination-Aware Ensemble (DAE), temporal modelling, continuous measurement, converging to an optimal fair allocation, feedback loops, strategic manipulation, regulating conditional probability distribution of disadvantaged sensitive attribute values, decreasing the probability of the favored sensitive attribute values, training a different model for every sensitive attribute value, and/or any other suitable method and/or approach.

Different subsystems and/or modules discussed above can be operated and controlled by the same or different entities. In the latter variants, different subsystems can communicate via: APIs (e.g., using API requests and responses, API keys, etc.), requests, and/or other communication channels.

Different processes and/or elements discussed above can be performed and controlled by the same or different entities. In the latter variants, different subsystems can communicate via: APIs (e.g., using API requests and responses, API keys, etc.), requests, and/or other communication channels.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various elements discussed above, and/or omit one or more of the discussed elements, wherein one or more instances of the method and/or processes described herein can be performed asynchronously (e.g., sequentially), concurrently (e.g., in parallel), or in any other suitable order by and/or using one or more instances of the systems, elements, and/or entities described herein.

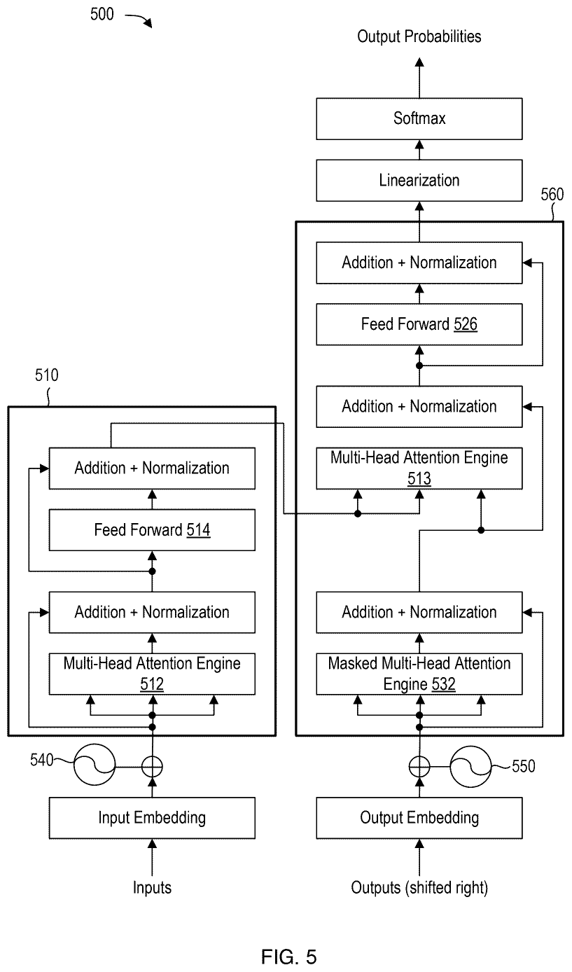

FIG. 5 is a block diagram of an example transformer in accordance with some aspects of the disclosure. In a convolutional neural network (CNN) model, the number of operations to relate signals from two arbitrary input or output positions grows in the distance between positions, which makes learning dependencies at different distant positions challenging for a CNN model. A transformer 500 reduces the operations of learning dependencies by using an encoder 510 and a decoder 560 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 510 is composed of a stack of six identical layers and each layer has two sub-layers. The first sub-layer is a multi-head self-attention engine 512, and the second sub-layer is a fully connected feed-forward network 514. A residual connection (not shown) connects around each of the sub-layers followed by normalization.

In this example transformer 500, the decoder 560 is also composed of a stack of six identical layers. The decoder also includes a masked multi-head self-attention engine 532, a multi-head attention engine 513 over the output of the encoder 510, and a fully connected feed-forward network 526. Each layer includes a residual connection (not shown) around the layer, which is followed by layer normalization. The masked multi-head self-attention engine 532 is masked to prevent positions from attending to subsequent positions and ensures that the predictions at position i can depend on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 540 to encode positions because the model does not contain recurrence and convolution and relative or absolute position of the tokens is needed. In the transformer 500, the positional encodings are added to the input embeddings at the bottom layer of the encoder 510 and the decoder 560. The positional encodings are summed with the embeddings because the positional encodings and embeddings have the same dimensions. A corresponding position decoder 550 is configured to decode the positions of the embeddings for the decoder 560.

In some aspects, the transformer 500 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 500 can process input sequences of variable length, making it well-suited for natural language processing tasks where input lengths can vary greatly. Additionally, the self-attention mechanism allows the transformer 500 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

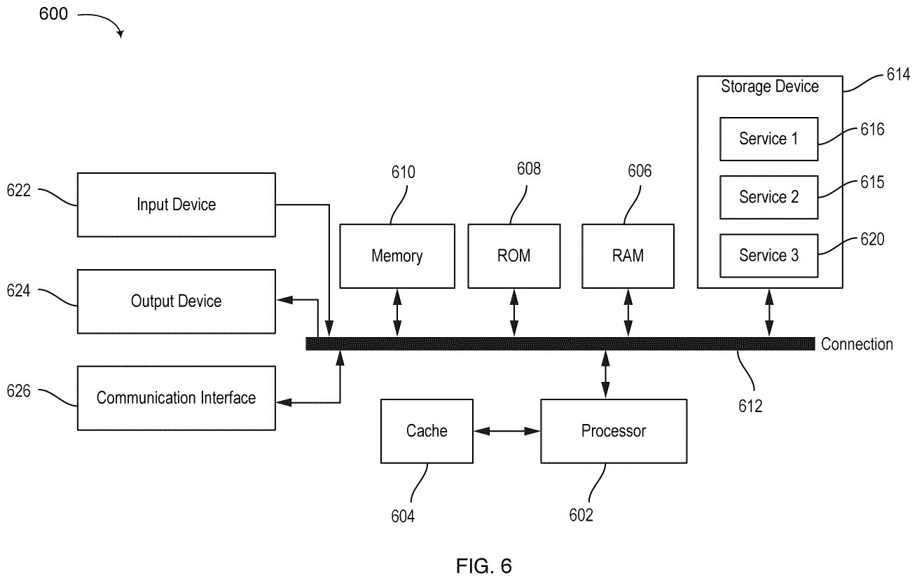

FIG. 6 illustrates an example computing system 600 of an example computing device which can implement the various techniques described herein. In some examples, the computing system can be part of a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing system 600 may include, implement, or be included in any or all of the presently disclosed systems for determining a living area of a property of interest. Additionally or alternatively, computing system 600 may be configured to perform any or all of the methods for determining a living area of a property of interest disclosed herein.

The components of computing system 600 are shown in electrical communication with each other using connection 612, such as a bus. The example computing system 600 includes a processing unit (CPU or processor) 602 and computing device connection 612 that couples various computing device components including computing device memory 610, such as read only memory (ROM) 608 and random-access memory (RAM) 606, to processor 602.

Computing system 600 can include a cache of high-speed memory connected directly with, in close proximity to, or integrated as part of processor 602. Computing system 600 can copy data from memory 610 and/or the storage device 614 to cache 604 for quick access by processor 602. In this way, the cache can provide a performance boost that avoids processor 602 delays while waiting for data. These and other models can control or be configured to control processor 602 to perform various actions. Other computing device memory 610 may be available for use as well. Memory 610 can include multiple different types of memory with different performance characteristics. Processor 602 can include any general-purpose processor and a hardware or software service, such as service 1 616, service 2 615, and service 3 620 stored in storage device 614, configured to control processor 602 as well as a special-purpose processor where software instructions are incorporated into the processor design. Processor 602 may be a self-contained system, containing multiple cores or processors, a bus, memory controller, cache, etc. A multi-core processor may be symmetric or asymmetric.

To enable user interaction with the computing system 600, input device 622 can represent any number of input mechanisms, such as a microphone for speech, a touch-sensitive screen for gesture or graphical input, keyboard, mouse, motion input, speech and so forth. Output device 624 can also be one or more of a number of output mechanisms known to those of skill in the art, such as a display, projector, television, speaker device, etc. In some instances, multimodal computing devices can enable a user to provide multiple types of input to communicate with computing system 600. Communication interface 626 can generally govern and manage the user input and computing device output. There is no restriction on operating on any particular hardware arrangement and therefore the basic features here may easily be substituted for improved hardware or firmware arrangements as they are developed.

Storage device 614 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 606, read only memory (ROM) 608, and hybrids thereof. Storage device 614 can include services 616, 615, and 620 for controlling processor 602. Other hardware or software models are contemplated. Storage device 614 can be connected to the computing device connection 612. In one aspect, a hardware model that performs a particular function can include the software component stored in a computer-readable medium in connection with the necessary hardware components, such as processor 602, connection 612, output device 624, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### 5. Illustrative Aspects of the Disclosure

Aspect 1. A method, comprising: generating, using a machine learning model, a feature map for each measurement of a set of measurements associated with a property of interest; determining, using the machine learning model, embeddings and corresponding positional encoding for a living area of the property of interest based on features in the feature maps; and determining, using the machine learning model, a weighted probability distribution representative of the living area based on the embeddings and corresponding positional encoding for the living area.

Aspect 2. The method of aspect 1, wherein the set of measurements comprises a plurality of images with different views.

Aspect 3. The method of aspect 2, wherein the plurality of images comprises at least one image encoding depth information.

Aspect 4. The method of aspect 1, further comprising: determining whether each measurement of the set of measurements satisfies a predetermined condition; and determining a set of solutions for the measurement and modifying the measurement based on the set of solutions based on whether the measurement satisfies the predetermined condition.

Aspect 5. The method of aspect 1, further comprising: determining a square footage of an image in the set of measurements; determining a living area ratio based on the weighted probability distribution and the square footage of the image; and predicting a value representative of the living area based on the living area ratio and the square footage of the image.

Aspect 6. The method of aspect 1, further comprising: appending a randomly initialized vector to the embedding.

Aspect 7. The method of aspect 1, wherein the machine learning model includes an encoder and a vision transformer.

Aspect 8. The method of aspect 7, wherein the vision transformer is configured to fuse the embeddings into a tokenized representation of the property of interest using attention of each measurement.

Aspect 9. The method of aspect 1, wherein the machine learning model is trained by: discretizing a target value range for a value representative of the living area into a plurality of non-equally spaced points; encoding the plurality of non-equally spaced points as non-negative weighted distributions; and training the machine learning model to predict softmax probability distributions over the plurality of non-equally spaced points.

Aspect 10. The method of aspect 1, further comprising: determining an uncertainty parameter associated with the weighted probability distribution representative of the living area.

Aspect 11. A system, comprising: a processor; and a memory containing instructions executable by the processor to: generate, using a machine learning model, a feature map for each measurement of a set of measurements associated with a property of interest; determine, using the machine learning model, embeddings and corresponding positional encoding for a living area of the property of interest based on features in the feature maps; and determine, using the machine learning model, a weighted probability distribution representative of the living area based on the embeddings and corresponding positional encoding for the living area.

Aspect 12. The system of aspect 11, wherein the set of measurements comprises a plurality of images with different views.

Aspect 13. The system of aspect 12, wherein the plurality of images comprises at least one image encoding depth information.

Aspect 14. The system of aspect 11, wherein the memory contains further instructions executable by the processor to: determine whether each measurement of the set of measurements satisfies a predetermined condition; and determine a set of solutions for the measurement and modify the measurement based on the set of solutions based on whether the measurement satisfies the predetermined condition.

Aspect 15. The system of aspect 11, wherein the memory contains further instructions executable by the processor to: determine a square footage of an image in the set of measurements; determine a living area ratio based on the weighted probability distribution and the square footage of the image; and predict a value representative of the living area based on the living area ratio and the square footage of the image.

Aspect 16. The system of aspect 11, wherein the machine learning model includes an encoder and a vision transformer.

Aspect 17. The system of aspect 16, wherein the vision transformer is configured to fuse the embeddings into a tokenized representation of the property of interest using attention of each measurement.

Aspect 18. The system of aspect 11, wherein the machine learning model is trained by: discretizing a target value range for a value representative of the living area into a plurality of non-equally spaced points; encoding the plurality of non-equally spaced points as non-negative weighted distributions; and training the machine learning model to predict softmax probability distributions over the plurality of non-equally spaced points.

Aspect 19. The system of aspect 11, wherein the memory contains further instructions executable by the processor to: determine an uncertainty parameter associated with the weighted probability distribution representative of the living area.

Aspect 20. A method, comprising: retrieving an image depicting a property of interest; generating a feature map for the image; determining a weighted probability distribution for a living area of the property of interest based on the feature map; determining a living area ratio based on the weighted probability distribution and an area of the image; and estimating, using a machine learning model, a value representative of the living area of the property of interest based on the living area ratio and the area of the image.

We claim:

1. A method, comprising:
generating, using a machine learning model, a feature map for each measurement of a set of measurements associated with a property of interest;
determining, using the machine learning model, embeddings and corresponding positional encodings for a living area of the property of interest based on features in the feature maps; and
determining, using the machine learning model, a weighted probability distribution representative of the living area based on the embeddings and corresponding positional encoding for the living area.

2. The method of claim 1, wherein the set of measurements comprises a plurality of images with different views.

3. The method of claim 2, wherein the plurality of images comprises at least one image encoding depth information.

4. The method of claim 1, further comprising:
determining whether each measurement of the set of measurements satisfies a predetermined condition; and
determining a set of solutions for the measurement and modifying the measurement based on the set of solutions based on whether the measurement satisfies the predetermined condition.

5. The method of claim 1, further comprising:
determining a square footage of an image in the set of measurements;
determining a living area ratio based on the weighted probability distribution and the square footage of the image; and
predicting a value representative of the living area based on the living area ratio and the square footage of the image.

6. The method of claim 1, further comprising:
appending a randomly initialized vector to the embedding.

7. The method of claim 1, wherein the machine learning model includes an encoder and a vision transformer.

8. The method of claim 7, wherein the vision transformer is configured to fuse the embeddings into a tokenized representation of the property of interest using attention of each measurement.

9. The method of claim 1, wherein the machine learning model is trained by:
discretizing a target value range for a value representative of the living area into a plurality of non-equally spaced points;
encoding the plurality of non-equally spaced points as non-negative weighted distributions; and
training the machine learning model to predict softmax probability distributions over the plurality of non-equally spaced points.

10. The method of claim 1, further comprising:
determining an uncertainty parameter associated with the weighted probability distribution representative of the living area.

11. A system, comprising:
a processor; and
a memory containing instructions executable by the processor to:
generate, using a machine learning model, a feature map for each measurement of a set of measurements associated with a property of interest;
determine, using the machine learning model, embeddings and corresponding positional encodings for a living area of the property of interest based on features in the feature maps; and
determine, using the machine learning model, a weighted probability distribution representative of the living area based on the embeddings and corresponding positional encoding for the living area.

12. The system of claim 11, wherein the set of measurements comprises a plurality of images with different views.

13. The system of claim 12, wherein the plurality of images comprises at least one image encoding depth information.

14. The system of claim 11, wherein the memory contains further instructions executable by the processor to:
determine whether each measurement of the set of measurements satisfies a predetermined condition; and
determine a set of solutions for the measurement and modify the measurement based on the set of solutions based on whether the measurement satisfies the predetermined condition.

15. The system of claim 11, wherein the memory contains further instructions executable by the processor to:
determine a square footage of an image in the set of measurements;
determine a living area ratio based on the weighted probability distribution and the square footage of the image; and
predict a value representative of the living area based on the living area ratio and the square footage of the image.

16. The system of claim 11, wherein the machine learning model includes an encoder and a vision transformer.

17. The system of claim 16, wherein the vision transformer is configured to fuse the embeddings into a tokenized representation of the property of interest using attention of each measurement.

18. The system of claim 11, wherein the machine learning model is trained by:
discretizing a target value range for a value representative of the living area into a plurality of non-equally spaced points;
encoding the plurality of non-equally spaced points as non-negative weighted distributions; and
training the machine learning model to predict softmax probability distributions over the plurality of non-equally spaced points.

19. The system of claim 11, wherein the memory contains further instructions executable by the processor to:
determine an uncertainty parameter associated with the weighted probability distribution representative of the living area.

20. A method, comprising:
retrieving an image depicting a property of interest;
generating a feature map for the image;
determining a weighted probability distribution for a living area of the property of interest based on the feature map;
determining a living area ratio based on the weighted probability distribution and an area of the image; and
estimating, using a machine learning model, a value representative of the living area of the property of interest based on the living area ratio and the area of the image.
